(19) United States
(12) Patent Application Publication
(10) Pub. No.: US 2014/0337056 A1
(43) Pub. Date: Nov. 13, 2014

(54) SAMPLING METHOD FOR PERFORMING SAMPLING IN AN UNMISTAKEABLE MANNER

(71) Applicant: GREINER BIO-ONE GMBH, Kremsmuenster (AT)

(72) Inventor: Christoph Rampetsreiter, Kremsmuenster (AT)

(73) Assignee: GREINER BIO-ONE GMBH, Kremsmuenster (AT)

(21) Appl. No.: 14/351,229

(22) PCT Filed: Oct. 12, 2012
(86) PCT No.: PCT/AT2012/050162

§ 371 Date: Jul. 25, 2014

(30) Foreign Application Priority Data
Oct. 12, 2011 (AT) A 1477/2011

(51) Int. Cl. G06F 19/00; G06K 7/14; G06F 17/30

(52) U.S. Cl. CPC G06F 19/366; G06F 17/30595; G06K 7/1404
USPC 705/3; 235/375

(57) ABSTRACT

The invention relates to a sampling method for performing sampling in an unmistakeable manner with execution on a data processing system having a data memory, wherein the data memory stores a plurality of sample-related and analysis-related data records and wherein the analysis-related data records are relationally linked to the sample-related data records, and wherein a user interface having an input/output apparatus is present which is communicatively connected to the data processing system. In this case, an order data record is produced from a captured first identification marker, particularly an identifier, from a first person and the subset of analysis-related data records and is stored in the data memory. Following performance of the sampling, an identification marker from a sampling container and a second identification marker from a second person are captured and an identifier which is read from the respective identification marker is stored in the order data record. In addition, a piece of type information is read from the stored explicit identifier of the sampling container and is compared with a piece of type information which is stored in the analysis-related data record of the subset, and a faulty match prompts the output of a first error message on the display means.

The invention relates to a sampling method for taking samples in a manner that reliably avoids mistakes performed on a data processing system with a data memory.

When taking a sample the known method involves documenting the allocation of the sample taken to the source of the sample in a reliable and traceable manner. In particular, in the preferred application in the healthcare sector the samples are mostly biological samples from a person, for example a patient in a hospital or medical practice. Said allocation is performed for example in that a specific identification label is generated for a patient, which is applied onto the sample container after taking the sample and thus the allocation is provided by means of said applied identifier. However, in day-to-day laboratory operations, particularly those with a large throughput of patients, this kind of allocation is very prone to error. The identification system, mostly an adhesive label, is applied to the sample container by a user either before or after taking the sample, whereby the system is completely reliant on the person taking the sample making sure that the sample containers of a patient do not get mixed up. Furthermore, when using this kind of system there is always a risk that the sample containers of different patients may get mixed up and thus false biological sample results may be obtained. In particular, when taking samples a specific sampling sequence can also be specified if necessary, for example if the sample source is contaminated by taking a sample. This may be the case if prior to taking the sample the patient is administered a substance for detecting a reaction of the body to the substance. All of the samples taken after giving said substance would then be contaminated by the substance however.

As analysis devices for evaluating biological samples mostly operate completely automatically and in particular have to read the applied identification marker automatically, in daily use there is increasingly a move away from the manual application of an identification marker. Particularly with adhesive labels there is a risk that the latter may be applied incorrectly or wrongly aligned, so that they cannot be read by the laboratory analysis device, which in most cases specifies very narrow tolerance ranges for the application of the identification marker, and thus the sample taken may possibly be invalid. However, this always means that a new sample needs to be taken from the patient. Therefore, sample taking containers are being used more and more on which a clear identification marker is already applied. Although this avoids the problem of applying identification markers, it does not ensure a clear allocation to a patient or ensure that a correct and valid sample has been taken. The clear traceability of the sample and in particular the correct implementation or sequencing of the sampling is not ensured by the known method. In particular, there is no guarantee that the sample has been taken systematically correctly, so that a possibly faulty sample is not recognized at a later stage of analysis. For example, there is no check to ensure whether the intended sample container has been used for the specific sampling.

The problem to be addressed by the invention is thus to create a sampling method which ensures clear traceability and which also prevents systematic errors when taking the sample.

The problem of the invention is solved in that the sampling method is performed on a data processing system with a data memory, whereby a plurality of sample-related and analysis-related data records are saved in the data memory and wherein the analysis-related data records are relationally linked to the sample-related data records. Furthermore, a user interface is provided with an input/output device, which user interface is connected communicatively to the data processing system. A first identification marker of a first person is detected and from the data memory the analysis-related data records are read and an analysis identifier is shown on a display means of the input/output device. For the preparation of treatments or for diagnosis an essential part of the diagnostic process and/or in the laboratory is to determine an analysis of relevant biological characteristics for a patient, for example a blood count. However, it is important that the characteristics to be determined are clearly assigned to the patient. As a first identification marker is assigned to a patient or generally to a first person, a clear identification of the person in the hospital is ensured. All possible analyses that can be performed are stored in the analysis-related data records, wherein on the display means as an analysis identifier an alphanumerical identifier of the corresponding analysis is shown for example. The alphanumerical identifiers are for example markers that are commonly in daily use in hospitals or laboratories, in order to identify specific characteristics which can be determined from a sample. Examples include LDH, GGT, CRP, PTT, but this list should in no way be considered to be conclusive, as further such alphanumerical identifiers will be known by a person skilled in the art.

After determining a subset of analyses by selecting at least one analysis identifier by means of the input device, from the first identification marker and the subset an order data record is formed and the latter is saved in the data memory. The sample-related data records linked relationally with the subset relational are also read and a sample identification marker saved in the sample-related data record, in particular an image, is shown on the display means.

After this the second person takes the sample and an identification marker of a sample container is determined and a clear identifier is read therefrom and said identifier is saved in the order data record. Likewise a second identification marker of a second person is determined and also saved in the order data record. The second person is usually the sample taker and as such must be suitably qualified for taking or removing the sample. For the purpose of quality control it is thus possible to clearly trace who the second person was who took the sample. A second person who is not sufficiently qualified can thus be rejected when detecting the second identification marker.

In order to evaluate the biological sample reliably it also needs to be ensured that the correct sample container is used for taking the sample. Therefore, type information is read from the clear identification marker of the sample container and compared with type formation saved in the analysis-related data record of the subset. If the wrong sample container has been used the comparison reveals an error so that it is possible to react to this straight away and the sample can be taken again if necessary. In particular, the second person is given a clear indication by the display means that the wrong sample container was used for the analysis defined by the subset.

A clear identifier is defined as an identification marker of the sample container which is allocated to the latter without being able to be manipulated, for example this can be achieved during the production of the container. The identifier can be a container for container-specific information, according to the present representation the type information of the sample container is saved along with other information.

However, it is also possible that not just the respective identifiers of the individual analyses are displayed but groupings are also possible, so that instead of the individual biological values a heading is shown. Thus for example an identifier “full blood count” could be shown under which all of the individual values relevant to the identifier are summarized. In addition, in the analysis-related data records for example a group identifier can be saved, or a group allocation table is also saved in the data memory defining a relational link between the analysis-related data records.

In the description reference is mostly made to procedures performed in a hospital. However, it should be emphasised that the method is not restricted to use in hospitals, but can be used anywhere where biological samples have to be taken from a person. In the text the terms first person and patient or second person and sample taker are used inter-changeably.

The data memory is in this case generally defined as a repository in which a plurality of data records can be deposited. In particular, it is a data base with a DBMS (data base management system). However, it is also possible for the data memory to be formed by a data file, in which the file the data records are saved. With regard to cloud systems, the data memory can also be in the form of a data memory integrated virtually from the cloud into the data processing system.

According to one development an instruction request is sent to the data processing system from a process management system, wherein the process management system and the data processing system communicate via a data exchange protocol, in particular HL7. As the sample taking and analysis of biological samples is occasionally an independent system or an independent department, even within a hospital, this development has the advantage that a request for a sample to be taken can be generated from a central management system, where the patient data is also mostly managed, and can thus be transferred directly by the present sampling method.

According to one development the first and/or second identification marker is read contactlessly, which has the advantage for example that it is possible to avoid any mix-up of the identifier of the first person from the incorrect entry of said identifier. The first identification marker can be attached firmly secured to the patient, for example as an armband, so that presentation is possibly awkward, or the condition of patients does not allow the presentation of the first identification marker so that contactless reading considerably increases the security of the detection. The second identification marker is assigned to the sample taker or is worn by the latter and needs to be detected during the sample taking or during actions in relation to the order data record. As this occurs many times over the course of a day this development has the advantage that time is saved and a wrong entry caused by inattention is prevented by means of the repeated detection of the second identification marker. If the contactless reading of the first and/or second identification marker fails, the identification marker can also be detected via an input means, for example a keyboard.

According to one development a barcode of an identifier marker is read as the first and/or second identification marker and has the advantage that optical barcode-reading devices are very widespread and thus often no additional equipment is needed for the present sampling method. Disposable armbands with a barcode are also commonly used for clear access and person identification and are mostly already in daily use in the healthcare system, in particular in hospitals.

According to one development an identifier of an HF identifier mark is read as a first and/or second identification marker. HF identifier marks, in particular RFID tags, enable the secure reading of the identification marker, without an identification mark having to be shown. In particular, an identification mark of this kind can be worn hidden from view but can still be read reliably. By means of a suitable configuration of the reading characteristics it can also be ensured that in the case of a plurality of identification marks only one specific mark is read.

As there is always less of a risk of confusion with a visual representation of an article than with an alphanumerical identifier, according to one development an image of a container is read and represented from the sample-related data record as a sample identification marker. As it has proved to be advantageous to mark the sample containers by having different coloured end caps the image represented according to the claims preferably comprises a coloured representation of the end cap. The end cap can also have an additional colour coding ring; mostly the latter is arranged on the end face so that preferably an oblique view of the end cap is shown.

According to one development a plurality of different barcodes can be used as the identification marker of the sample container, whereby in the identification marker a clear identifier is saved in coded form. In particular, a single barcode or two different barcodes can be provided which ensures compatibility with existing detection means. For example, the barcode can be selected from a group including UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE.

Furthermore, at least one identifier from a group comprising the manufacturer identifier, manufacture time stamp, use period, batch number and article number is read from the clear identifier of the sample container. An advantage of this development is in particular in that in this way it is possible to trace the individual container back to its manufacture. A sample container is part of a manufactured batch and because of the batch size it is mostly the case that the containers from one batch will be delivered to a plurality of different users. If in the case of a faulty sample container the manufacturer identifier is sent to a detection service of the manufacturer it is possible to identify a manufacturing problem associated with a batch very quickly. This is preferably communicated automatically in that for a faulty sample container the identification marker is detected and the identifier is sent automatically to the detection service by the data processing system. From the incoming identification of faulty sample containers the detection service can derive quality information about the whole batch.

As particularly for sample containers in the medical field a permissible use period is defined according to the manufacture of the container, it is an advantage if a time period is established from the production time stamp and an order date saved in the order data. If a use period threshold is exceeded a second error message is sent to the display means. Thus when detecting the identifier of the sample container it is established whether the container still meets the requirements for taking the sample. For example a bioactive material can be arranged in the sample container which can only be used for a maximum permissible time period.

For the purposes of quality control and the traceability of the stages of the sampling method it is an advantage if a detection time stamp is saved in the order data record on detection of the clear identifier of the sample container.

For some analyses it may be necessary that a maximum time period is not exceeded between taking the sample and the analysis. Therefore, according to one development a time period is determined by an analysis system from the detection time stamp and an analysis time stamp and on exceeding a time period maximum a third error message is sent to the data processing system.

In addition to sample containers that already have a clear identifier other sample containers can also be used, for example containers of third-party suppliers with a non-compatible identifier. Therefore, according to one development on reading the sample-related data records linked relationally to the subset, for a specific sample-related data record a marking label can be produced. Said label can then be placed on the sample container for example by adhesion so that at any time also any other containers can be used for the present method.

According to one development the release of a first and/or second and/or third error message determines an error status, wherein in the case of an error status, for the sample-related data record of the order data record generating the error message, an invalid marker is saved in the order data record. This has the advantage that in case of error steps can be taken automatically to prevent an incorrectly taken sample remaining in the analysis process thus rendering the whole analysis process invalid.

In this respect a development is also an advantage in which for the sample-related data record generating the error message a further order data record is generated. Thus in case of an error a new request relating to the specific sample is generated automatically, so that the analysis process is not impaired by this. In particular, this prevents the case where an incorrectly taken sample is only identified at a subsequent stage of analysis and prevents a considerable amount of extra work as the patient would have to return for another sample to be taken.

To document the sample taking sequence and to provide traceability of the already taken sample for the sample taker, according to one development after each step of the method a process step marking is saved in the order data record. In this way it is possible to trace for samples that are not taken consecutively which samples have already been taken. This can occur for example when additional biological samples need to be taken before and/or after a long period of sample taking.

As a plurality of users can be on one data processing system and in this way plurality of patients can be attended at the same time, according to one development a third identifier of a further second person is detected and the order data record linked to the second identifier of the second person is returned to the data memory and order data record of the further second person linked to the third identifier are loaded from the data memory and the subset or the sample identification marker is shown on the display means.

In particular, according to one development when reading the order data record linked to the third identifier the process step identifier is read, and a multiple use of the data processing device, in particular of the input/output device, is made possible. In this case it is always ensured that each user can continue to perform his work without having to first navigate back to the most recently performed work step.

According to one development in the analysis-related data record for the relationally linked sample-related data records a sequence is saved, wherein the sequence is read and the sample identification marker of the linked sample-related data records, arranged in sequence, is displayed on the display means. For example, it may be necessary during a sample taking sequence for the patient to take something after which his reaction is determined. Therefore, also the individual samples ned to be taken in a specific sequence, wherein this development has the advantage that the user is shown on the display means which sample is to be taken and which sample container is to be used. By means of the present method, in particular as type information is determined from the detected identification marker of the sample container, it is ensured that a faulty sequence of the samples is noticed during the detection of the sample container and thus measures can be taken directly as long as the patient is still on site.

For a better understanding of the invention the latter is explained in more detail with reference to the following Figures.

In a schematically much simplified representation:

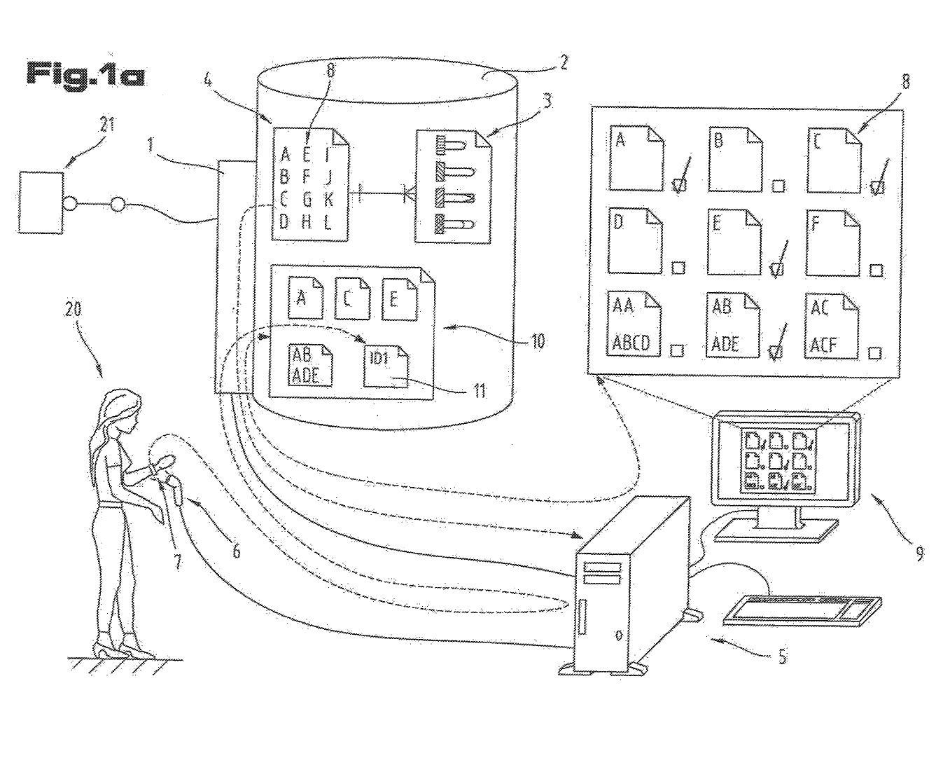

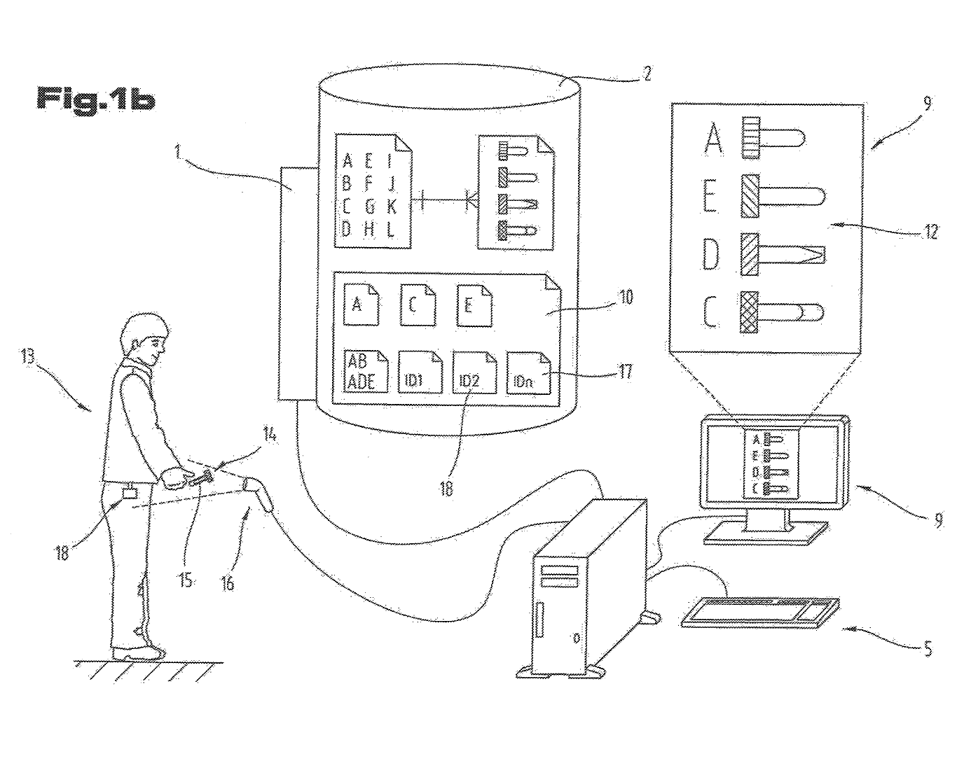

FIGS. 1a) and b) shows a representation of system which performs the steps of the present sampling method;

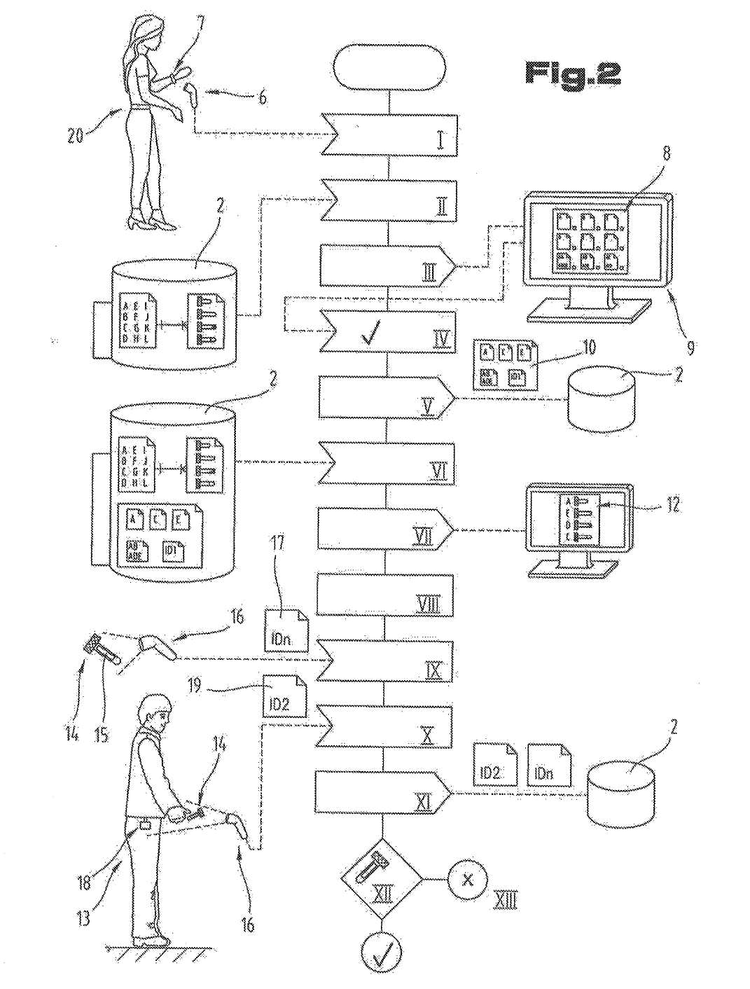

FIG. 2 shows a simplified flow chart of the present method.

FIGS. 1a and 1b show schematically the individual components of a device for performing the present sampling method. The sampling method is performed on a data processing system 1 comprising a data memory 2. In the data memory 2 a plurality of analysis-related 4 data records are saved which are linked relationally with sample-related data records 3. Furthermore, a user interface 5 is connected communicatively with the data processing system 1.

According to the claims as a first method step a clear identification marker 7 of a first person 20 is detected. This can be performed for example in that an arm band with a printed or integrated code is read, wherein an armband with a printed barcode read by an optical reading device 6 is preferred. Said reading device 6 is configured for example as a laser scanner, which is in widespread use and is generally available in institutions which take samples so that no additional new investment is necessary. The first identification marker 7 can be in the form of an armband with an anti-removal safety device so that it can be fitted once onto a person but can only be removed by destroying the closure or the band.

From the data memory the saved, analysis-related data records 4 are read and the analysis identifier 8 saved in the analysis-related data record 4 is displayed on display means 9 of the input device of the user interface 5. For the analysis-related data records 4 for example two basic types are represented. On the one hand each analysis-related data record corresponds to exactly one sample-related data record 3, so that for a selected analysis precisely one sample needs to be taken. On the other hand analysis-related data records are provided which refer to a plurality of sample-related data records, so that on selecting such an analysis a plurality of samples need to be taken. An example of this is if an analysis identifier 8 “full blood count” is selected for a patient as the analysis to be performed, whereby automatically by the relational link of the analysis-related data records 4 to the sample-related data records 3, the corresponding selection of sample-related data records 3 is made and thus the necessary number of samples is taken.

An operator then selects by means of an input means from the analysis identifiers 8 shown on the display means 9 which of the latter need to be performed for the patient in question. From the detected first identification marker 7, in particular the identifier 11 linked therewith, and the selection of analysis identifiers 8, an order data record 10 is created by the data processing system 1 and saved in the data memory 2. In said order data record 10 reference identifiers for the selected analyses to be performed (A, C, E, AB), and the clear identifier 11 of the first performed read from the first identification marker are saved.

FIG. 1b shows the following method steps. For the order data record 10 saved in the data memory 2 the references saved on the analysis-related data records are analysed and the sample-related data records 3 relationally linked to said subset are read. The sample identification markers 12 saved in the sample-related data records are then displayed on the display means 9. These sample identification markers are preferably an image of the relevant sample container. In particular, the latter is an image of the end cap of the container, as the caps are colour-coded to distinguish the containers and if necessary comprise additional colour rings. As on the basis of the analyses to be performed if necessary a sequence of the sample taking has to be adhered to, on the display means 9 the sample identification markers 12 are shown in the corresponding sequence of use.

When taking the sample the second person 13, the sample taker, takes the first specified sample container, takes the sample and documents the sample taking in the order data record. In addition, each sample container 14 has a clear identification marker 15 which is detected by means of a reading device 16 and the identifier 17 read from the first identification marker 15 is saved in the order data record 10. In addition, a second identification marker 18 of the second person 13 is determined and the identifier 19 read from the second identification marker 18 is also saved in the order data record 10. The second identification marker 18 can be in the form of an employee identification card for example, which identifies the second person 13 as an authorised employee of the institution performing the sampling. Preferably, said second identification marker 18 also comprises the identifier in the form of a barcode, as in this way the multiple use of the reading device 16 is possible and in particular no additional reading devices need to be acquired. The identification marker 15 of the sample container 14 also has a barcode for reasons of compatibility or a multiple use of provided reading devices, wherein it is an advantage in particular if two different barcodes are applied, as in this way there is compatibility with existing reading devices established on the market. Furthermore, a second barcode can be configured to include additional information, so that it is possible for example to trace the individual sample container back to its manufacturer.

To perform the analysis correctly it is now important that on the one hand the correct sample containers are used, if necessary in the corresponding sequence, and that in particular time criteria relating to the use of the sample container are adhered to. In addition, it is preferable in the identification marker 15 of the sample container 14, or in the save identifier 17, to save in coded form the type of sample container and a manufacturing date and/or use date. From this information and from type information saved in the analysis-related data record of the subset or from time stamp information saved in the order data record 10 or assigned to the latter, a comparison can be performed to see whether on the one hand the sample container necessary for this analysis was used or whether a defined period of use determined by sterilisation requirements was adhered to.

If an error is detected during this check an error message is sent to the display means 9, so that the corresponding sample taking can be repeated using a correct sample container. This has the advantage in particular that the error is picked up whilst the patient is still present and thus the patient does not need to be recalled to repeat the sample taking.

The processes represented in FIGS. 1a and 1b can be performed combined in one place, i.e. in that the first person 20 appears at the place at which the sample is to be taken and a second person 13 sets up or selects the analysis to be performed and thereby forms the order data record. Furthermore, said second person 13 can then take the sample and assign the identifiers.

By means of the present sample taking method it is also possible however that the selection of analyses to be performed and thereby the generation of the order data record can be performed in a different location from the sample taking, for example it can be defined by a doctor when visiting the ward. The sample taking and thereby the performing of the method steps by the second person 13 then take place in the laboratory. As the order data record and thereby all of the data records relevant to the sample taking are saved in the data memory 2 of a central data processing systems 1, even the various different systems involved in the sample taking can access the order data record 10.

As furthermore a present sampling method is mostly integrated into a superordinate process and as is the case in a hospital can be requested by a plurality of different specialist departments, it is an advantage if the sampling method can be activated directly by a superordinate management system. In the healthcare system a communication protocol HL7 is used widely which enables different systems to communicate via an interface and the common protocol. Therefore, the data processing system has an interface with a process management system 21, wherein the communication with the process management system 21 is performed via said interface, preferably by means of HL7. The management system 21 can thus generate an analysis request and transmit this directly to the data processing system 1, so that the method steps relating to the formation of the analysis subset were already performed by the process management system. The present method also includes the fact that the method steps for forming the analysis-subset are performed on the user interface 5 of the data processing system 1, and/or are transmitted via an interface from the process management system 21 to the data processing system 1.

FIG. 2 shows a representation of the method steps as a flow chart.

As a first method step I after the start a first identification marker 7 of a first person 20 is read by a reading device 6. Then II from the data memory 2 the analysis-related data records are read and in the next step III the analysis identifiers 8 saved in the analysis-related data records are represented on a display means 9. A user then selects for example by means of an input device a subset of the displayed analysis identifiers 8 IV, for example in which those analysis identifiers are marked which are to perform corresponding analyses for the relevant patient. From the first identification marker, in particular from an identifier selected therefrom and the selected subset of analysis identifiers 8, in the next step V an order data record 10 is generated and saved in the data memory 2.

It should be noted here in particular that the first method step I, i.e. the detection of the first identification marker of the first person, can also be performed after forming the analysis subset IV.

Afterwards the sample-related data records linked relationally with the subset of the selection are read from the data memory 2 VI and sample identification marker 12 saved in the sample-related data record, in particular an image, is displayed on the display means. The sample taker thus receives information about which sample containers need to be used, if necessary also the sequence of samples to be taken is defined.

After performing the sample taking VIII by means of a reading device 16 an identification marker 15 of the container 14 currently used for taking the sample is detected and an identifier 17 saved in said identification marker 15 is read IX. Likewise by means of the reading device 16 a second identification marker 18 of the second person 13, i.e. the sample taker, is determined and the identifier 19 saved in the identification marker 18 is read X. The read identifier of the sample container and the read identifier of the second identification marker of the sample taker are saved in the order data record in the data memory 2 XI.

With regard to the method steps VIII to X it should be noted that the sequence shown here corresponds to a possible sequence and that said sequence can be changed to achieve a more efficient process. In the case of a combined implementation of the present sample taking method at a user interface, in particular the detection of the second identification marker 18 of the second person 13 (method step X) can also be performed earlier in the process, for example at the beginning or during the detection of the first identification marker 7 of the first person 20.

From the identifiers saved in the order data record and the selection of analyses to be performed a comparison is now performed XII to establish whether the currently used sample container is permitted for the analysis to be performed and also whether the use period permissible for the sample container has been adhered to.

In case of error XIII an error message is sent and the sample taker 13 can react accordingly and repeat the sample taking. After a successful comparison the next sample is taken (step VIII) or the sampling method is completed correctly.

The advantage of the present sampling method is in particular that it is possible to identify directly when taking the sample if a faulty sample has been taken because of an unpermitted sample container, which is an advantage for the patient in particular as the latter does not need to return to have the sample taken again. Furthermore, this ensures the smooth detection and traceability of the sample taking from determining the subset of analyses to be performed to assigning the sample container for analysis and in particular there is a clear allocation of the filled sample container to the patient and sample taker. Lastly, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions.

All of the details relating to value ranges in the present description are defined such that the latter include any and all part ranges, e.g. a range of 1 to 10 means that all part ranges, starting from the lower limit of 1 to the upper limit 10 are included, i.e. the whole part range beginning with a lower limit of 1 or above and ending at an upper limit of 10 or less, e.g. 1 to 1.7, or 3.2 to 8.1 or 5.5 to 10.

The exemplary embodiments show possible embodiment variants of the sampling method, whereby it should be noted at this point that the invention is not restricted to the embodiment variants shown in particular, but rather various different combinations of the individual embodiment variants are also possible and this variability, due to the teaching on technical procedure, lies within the ability of a person skilled in the art in this technical field. Thus all conceivable embodiment variants, which are made possible by combining individual details of the embodiment variants shown and described, are also covered by the scope of protection.

The underlying problem addressed by the present invention can be taken from the description.

Mainly the individual embodiments shown in the Figures can form the subject matter of independent solutions according to the invention. The problems and solutions according to the invention relating thereto can be taken from the detailed descriptions of these figures.

### LIST OF REFERENCE NUMBERS

| | |
|---|---|
| 1 | data processing system |
| 2 | data memory |
| 3 | sample-related data record |
| 4 | analysis-related data record |
| 5 | user interface |
| 6 | reading device |
| 7 | first identification marker |
| 8 | analysis identifier |
| 9 | display means |
| 10 | order data record |
| 11 | identifier |
| 12 | sample identification marker |
| 13 | second person, sample taker |
| 14 | sample container |
| 15 | identification marker |
| 16 | reading device |
| 17 | identifier |
| 18 | second identification marker |
| 19 | identifier |
| 20 | first person, patient |
| 21 | process management system |

1. A sampling method for taking a sample in a manner that reliably avoids mistakes performed on a data processing system (1) with a data memory (2),
wherein
in the data memory (2) a plurality of sample-related (3) and analysis-related (4) data records are saved and wherein the analysis-related data records (4) are relationally linked with the sample-related data records (3),
and wherein a user interface (5) with an input/output device is provided which is connected communicatively to the data processing system (1),
comprising the steps:
detecting a first identification marker (7) of a first person (20);
reading the analysis-related data records (4) and representing an analysis identifier (8) on a display means (9) of the input/output device;
determining a subset of analyses by selecting at least one analysis identifier (8) by means of the input device;
forming an order data record (10) from the first identification marker (7), in particular an identifier (11), and the subset and saving the order data record (10) in the data memory (2);
reading the sample-related data records (3) relationally linked with the subset and displaying a sample identification marker (12) saved in the sample-related data record, in particular an image, on the display means (9);
performing the sample taking;
detecting a second identification marker (18) of a second person (13) and saving an identifier (17) read from the identification marker (18) in the order data record (10);
detecting an identification marker (15) of a sample container (14) and reading a clear identifier (17) and saving said identifier (17) in the order data record (10);
reading type information from the saved clear identifier (17) of the sample container (14) and comparing with type information saved in the analysis-related data record (4) of the subset;
if there is no correlation sending a first error message to the display means.

2. The sampling method as claimed in claim 1, wherein an instruction request is sent to the data processing system (1) by a process management system (21), wherein the process management system (21) and the data processing system (1) communicate via a data exchange protocol, in particular HL7.

3. The sampling method as claimed in claim 1, wherein the first (7) and/or second (13) identification marker is read contactlessly.

4. The sampling method as claimed in claim 3, wherein a barcode of an identifier mark is read as the first (7) and/or second (13) identification marker.

5. The sampling method as claimed in claim 3, wherein an identifier of an HF identifier mark is read as a first (7) and/or second (13) identification marker.

6. The sampling method as claimed in claim 1, wherein an image of a container is read and displayed as the sample identification marker (12).

7. The sampling method as claimed in claim 1, wherein as an identification marker (15) of the sample container (14) a barcode is registered from a group comprising UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE and from the latter a clear identifier (17) is read.

8. The sampling method as claimed in claim 1, wherein the clear identifier (17) of the sample container (14) includes at least one of the group: manufacturer identifier, manufacture time stamp, use period, batch number and article number.

9. The sampling method as claimed in claim 8, wherein from the manufacture time stamp and an order date saved in the order data record (10) a time period is determined, wherein on exceeding a threshold value for the use period a second error message is displayed, for example on the display means.

10. The sampling method as claimed in claim 1, wherein on the detection of the identification marker (15) of the sample container (14) a detection time stamp is saved in the order data record (10).

11. The sampling method as claimed in claim 10, wherein by means of an analysis system from the detection time stamp and an analysis time stamp a period of time is defined and if a maximum period of time is exceeded a third error message is sent to the data processing system (1).

12. The sampling method as claimed in claim 1, wherein on reading the sample-related data records (3) relationally linked to the subset for a specific sample-related data record a marking label is produced.

13. The sampling method as claimed in claim 1, wherein the release of a first and/or second and/or third error message determines an error status, wherein in the case of an error status, for the sample-related data record (3) of the order data record (10) generating the error message, an invalid marker is saved in the order data record (10).

14. The sampling method as claimed in claim 13, wherein for the sample-related data record (3) generating the error message a further order data record (10) is generated.

15. The sampling method as claimed in claim 1, wherein after each method step a process step marking is saved in the order data record (10).

16. The sampling method as claimed in claim 1, wherein a third identifier of a further second person is detected and the order data record (10) linked to the second identifier (18) of the second person (13) is returned to the data memory (2), and the order data record of the second person linked to the third identifier is loaded from the data memory (2) and the subset or the sample identification markers (12) are displayed on the display means (9).

17. The sampling method as claimed in claim 15, wherein when reading the order data record linked to the third identifier the process step marking is read.

18. The sampling method as claimed in claim 1, wherein in the analysis-related data record (4) for the relationally linked sample-related data records (3) a sequence is saved, wherein the sequence is read and the sample identification markers (12) of the linked sample-related data records (3) are shown on the display means (8), arranged in sequence.
